(19) United States
(12) Patent Application Publication
(10) Pub. No.: US 2026/0201191 A1
(43) Pub. Date: Jul. 16, 2026

(54) AQUEOUS INK FOR INKJET RECORDING

(71) Applicant: KYOCERA DOCUMENT SOLUTIONS INC., OSAKA (JP)

(72) Inventor: KAI IKETAKI, OSAKA (JP)

(21) Appl. No.: 19/446,950

(22) Filed: Jan. 13, 2026

(30) Foreign Application Priority Data
Jan. 15, 2025 (JP) 2025-005672

(51) Int. Cl. C09D 11/38; C09D 11/107; C09D 11/322; C09D 11/326

(52) U.S. Cl. CPC C09D 11/38; C09D 11/107; C09D 11/322; C09D 11/326

(57) ABSTRACT

An aqueous ink for inkjet recording includes a pigment, a compound represented by the following general formula (1), a glycol ether, and water. The glycol ether is at least one selected from propylene glycol monomethyl ether, propylene glycol monopropyl ether, dipropylene glycol monomethyl ether, dipropylene glycol monopropyl ether, and triethylene glycol monobutyl ether. A content of the compound represented by the following general formula (1) is 10 mass parts or more and 80 mass parts or less with respect to a total of 100 mass parts of the compound represented by the following general formula (1) and the glycol ether: HO—(CH₂(CH₃)CHO)ₙ—H . . . (1). In the above general formula (1), n represents an average number of repeating oxypropylene groups and is an integer of 3 or more and 17 or less.

### CROSS-REFERENCE TO RELATED PATENT APPLICATION

This application claims the benefit of Japanese Priority Patent Application JP 2025-005672 filed on Jan. 15, 2025, the entire contents of which are incorporated herein by reference.

### FIELD OF THE DISCLOSURE

The present disclosure relates to an aqueous ink for inkjet recording.

### BACKGROUND OF THE DISCLOSURE

In inkjet recording using an aqueous ink, there is a demand for improved image density on plain paper. For example, there is known an ink containing a pigment, a specific polymer compound, and water.

### SUMMARY OF THE DISCLOSURE

An aqueous ink for inkjet recording according to one embodiment of the present disclosure includes a pigment, a compound represented by the following general formula (1), a glycol ether, and water.

The glycol ether is at least one selected from propylene glycol monomethyl ether, propylene glycol monopropyl ether, dipropylene glycol monomethyl ether, dipropylene glycol monopropyl ether, and triethylene glycol monobutyl ether.

A content of the compound represented by the following general formula (1) is 10 mass parts or more and 80 mass parts or less with respect to a total of 100 mass parts of the compound represented by the following general formula (1) and the glycol ether.

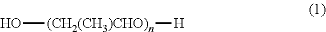

In the above general formula (1), n represents an average number of repeating oxypropylene groups and is an integer of 3 or more and 17 or less.

### DETAILED DESCRIPTION OF THE EXEMPLARY EMBODIMENTS

When using the conventional ink described above, image density on plain paper may be insufficient.

In view of the above circumstances, an object of the present disclosure is to provide an aqueous ink for inkjet recording capable of improving image density on plain paper.

Embodiments of the present disclosure will be described below.

An aqueous ink for inkjet recording of the present disclosure (hereinafter sometimes referred to simply as “ink”) includes a pigment, a compound represented by a general formula (1), a glycol ether, and water. The pigment, the compound represented by the general formula (1), the glycol ether, and the water are described below, respectively.

### (Compound Represented by General Formula (1))

The aqueous ink for inkjet recording of the present disclosure contains the compound represented by the following general formula (1).

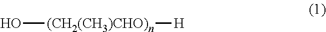

In the above general formula (1), n represents an average number of repeating oxypropylene groups and is an integer of 3 or more and 17 or less.

From the perspective of improving the image density, the average number of repeating oxypropylene groups is preferably 3 or more and 17 or less, and more preferably 7 or more and 12 or less. When the average number of repeating oxypropylene groups falls within this range, permeation of the pigment into the paper is suppressed, making it easier to improve the image density. When the average number of repeating oxypropylene groups is less than 3, it becomes difficult to obtain sufficient image density. When the average number of repeating oxypropylene groups is greater than 17, water solubility of the compound represented by the general formula (1) may decrease.

A commercially available product can be used as the compound represented by the general formula (1). Examples of the commercially available product include Sannix (registered trademark) PP-200 (n=3), Sannix PP-400 (n=7), Sannix PP-600 (n=10), Sannix PP-950 (n=16), Sannix PP-1000 (n=17) (all manufactured by Sanyo Chemical Industries, Ltd., product names); tripropylene glycol (isomer mixture) (n=3), polypropylene glycol, diol type, 400 (n=7), polypropylene glycol, diol type, 700 (n=12), polypropylene glycol, diol type, 1000 (n=17) (all manufactured by Fujifilm Wako Pure Chemical Corporation, product names).

From the perspective of improving the image density, a content of the compound represented by the general formula (1) is preferably 2 mass % or more and 16 mass % or less with respect to a total mass of the ink. When the content of the compound represented by the general formula (1) is within this range, permeation of the pigment into the paper is suppressed, making it easier to improve the image density. When the content of the compound represented by the general formula (1) is less than 2 mass %, the sufficient image density becomes difficult to obtain. When the content of the compound represented by the general formula (1) is greater than 16 mass %, the water solubility of the compound represented by the general formula (1) may decrease.

The compound represented by the general formula (1) may be used alone or in combination with two or more types.

### (Glycol Ether)

The aqueous ink for inkjet recording of the present disclosure contains the glycol ether. From the perspective of improving the image density, it is preferable that the glycol ether is at least one selected from propylene glycol monomethyl ether, propylene glycol monopropyl ether, dipropylene glycol monomethyl ether, dipropylene glycol monopropyl ether, and triethylene glycol monobutyl ether.

From the perspective of improving the image density, a content of the glycol ether is preferably 4 mass % or more and 18 mass % or less with respect to the total mass of the ink. When the content of the glycol ether falls within this range, permeation of the pigment into the paper is suppressed, making it easier to improve the image density. When the content of the glycol ether is less than 4 mass %, it becomes difficult to obtain the sufficient image density. When the content of the glycol ether is greater than 18 mass %, storage stability of the ink may decrease.

From the perspective of improving the image density, the content of the compound represented by the general formula (1) is preferably 10 mass parts or more and 80 mass parts or less with respect to a total of 100 mass parts of the compound represented by the general formula (1) and the glycol ether. When the content of the compound represented by the general formula (1) is within this range, permeation of the pigment into the paper is suppressed, making it easier to improve the image density.

### (Other Water-Soluble Organic Solvents)

The aqueous ink for inkjet recording of the present disclosure may further contain water-soluble organic solvents (hereinafter referred to as “other water-soluble organic solvents”) other than the compound represented by the general formula (1) and the glycol ether mentioned above. Examples of the other water-soluble organic solvents are not particularly limited, but include 1,2-propanediol, 1,3-propanediol, 2-methyl-1,3-propanediol, 3-methyl-1,3-butanediol, 1,2-pentanediol, 1,5-pentanediol, 3-methyl-1,5-pentanediol, dipropylene glycol, glycerin, and 2-pyrrolidone.

### (Water)

The water contained in the aqueous ink for inkjet recording of the present disclosure is preferably ion-exchanged water (deionized water). A content of the water is preferably 55 mass % or more and 80 mass % or less with respect to the total mass of the ink.

### (Pigment)

Examples of the pigment contained in the aqueous ink for inkjet recording of the present disclosure are not particularly limited, but include the following pigments.

As a black pigment, carbon black produced by a furnace method or a channel method may be used.

A commercially available carbon black includes, for example, Raven (registered trademark) 5000 Ultra II, Raven 3500, Raven 2000, Raven 1255, Raven 1250, Raven 1200, Raven 1190 Ultra, Raven 1170, Raven 1080 Ultra, Raven 1060 Ultra (all manufactured by Aditya Birla Chemicals Ltd., product names); MONARCH (registered trademark) 1300, MONARCH 1000, MONARCH 800, MONARCH 700, MOGUL (registered trademark) L, REGAL (registered trademark) 400R, REGAL 660R, REGAL 330R (all manufactured by Cabot Corporation, product names); Mitsubishi (registered trademark) Carbon Black #2300, Mitsubishi Carbon Black #980, Mitsubishi Carbon Black #970, Mitsubishi Carbon Black #960, Mitsubishi Carbon Black #950, Mitsubishi Carbon Black #900, Mitsubishi Carbon Black #850, Mitsubishi Carbon Black MCF88, Mitsubishi Carbon Black MA600, Mitsubishi Carbon Black #52, Mitsubishi Carbon Black #47, Mitsubishi Carbon Black #45, Mitsubishi Carbon Black #40, Mitsubishi Carbon Black #33, Mitsubishi Carbon Black #25, Mitsubishi Carbon Black MA7, Mitsubishi Carbon Black MA8, Mitsubishi Carbon Black MA100 (all manufactured by Mitsubishi Chemical Corporation, product names); COLOR BLACK FW 1, COLOR BLACK FW 2, COLOR BLACK FW 200, COLOR BLACK FW 18, PRINTEX (registered trademark) 80, PRINTEX 85, SPECIAL BLACK 6, COLOR BLACK S 160, SPECIAL BLACK 5, PRINTEX U, PRINTEX V, SPECIAL BLACK 4, SPECIAL BLACK 4A, PRINTEX 140 U, PRINTEX 140 V, PRINTEX 35 (all manufactured by Orion Engineered Carbons, Inc., product names).

As a cyan pigment, examples include C.I. Pigment Blue 1, C.I. Pigment Blue 2, C.I. Pigment Blue 3, C.I. Pigment Blue 15:3, C.I. Pigment Blue 15:4, C.I. Pigment Blue 16, C.I. Pigment Blue 22, C.I. Vat Blue 4, and C.I. Vat Blue 6.

As a magenta pigment, examples include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202, and C.I. Pigment Violet 19.

As a yellow pigment, examples include C.I. Pigment Yellow 12, C.I. Pigment Yellow 13, C.I. Pigment Yellow 14, C.I. Pigment Yellow 17, C.I. Pigment Yellow 74, C.I. Pigment Yellow 83, C.I. Pigment Yellow 93, C.I. Pigment Yellow 94, C.I. Pigment Yellow 95, C.I. Pigment Yellow 120, C.I. Pigment Yellow 128, C.I. Pigment Yellow 138, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185.

Other pigments include, for example, C.I. Pigment Green 7, C.I. Pigment Green 10, C.I. Pigment Green 36, C.I. Pigment Brown 3, C.I. Pigment Brown 5, C.I. Pigment Brown 25, C.I. Pigment Brown 26, C.I. Pigment Orange 2, C.I. Pigment Orange 5, C.I. Pigment Orange 7, C.I. Pigment Orange 13, C.I. Pigment Orange 14, C.I. Pigment Orange 15, C.I. Pigment Orange 16, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 62, C.I. Pigment Orange 63, C.I. Pigment Orange 64, and C.I. Pigment Orange 71.

The pigment may be used alone or in combination with two or more types.

From the perspective of ensuring ink ejection stability, a content of the pigment is preferably 0.1 mass % or more and 15 mass % or less with respect to the total mass of the ink.

The pigment is typically dispersed in a dispersion medium for use. A method of dispersing the pigment is not particularly limited, but examples include dispersing the pigment in the dispersion medium using a dispersant, or dispersing the pigment in the dispersion medium without the dispersant. Examples of the dispersant include a polymeric dispersant (hereinafter referred to as a “pigment dispersion resin”).

From the perspective of ensuring dispersion stability of the pigment, it is preferable for the pigment dispersion resin to have an acid group, and it is particularly preferable for it to have both an acid group and an aromatic group.

Examples of such pigment dispersion resin include a (meth)acrylic resin, a styrene-(meth)acrylic resin, a styrene-maleic resin, and an urethane resin. Among these, it is preferable to use the styrene-(meth)acrylic resin.

In this specification, (meth)acrylic means at least one selected from acrylic and methacrylic.

Specific examples of the pigment dispersion resin having the acid group and the aromatic group include a styrene-(meth)acrylic acid copolymer, a styrene-(meth)acrylic acid-(meth)acrylic acid ester copolymer, a styrene-α-methylstyrene-(meth)acrylic acid copolymer, a styrene-α-methylstyrene-(meth)acrylic acid-(meth)acrylic ester copolymer, a styrene-maleic acid copolymer, a styrene-maleic anhydride copolymer, and a vinylnaphthalene-(meth)acrylic acid copolymer.

When the pigment dispersion resin is a styrene-(meth)acrylic resin, a content of a constituent unit derived from styrene in the styrene-(meth)acrylic resin is preferably 50 mass % or more and 90 mass % or less, and more preferably 70 mass % or more and 90 mass % or less with respect to total constituent units of the styrene-(meth)acrylic resin.

When the pigment dispersion resin is the styrene-(meth)acrylic resin, a content of constituent units derived from (meth)acrylic acid in the styrene-(meth)acrylic resin is preferably 10 mass % or more and 40 mass % or less with respect to the total constituent units of the styrene-(meth)acrylic resin.

The pigment dispersion resin may be any of a random copolymer, a block copolymer, or a graft copolymer.

Examples of the acid group include a carboxyl group, a phosphate group, and a sulfo group. Among these, the carboxyl group is preferred.

An acid value of the pigment dispersion resin is preferably 50 mg KOH/g or more and 400 mg KOH/g or less, and more preferably 50 mg KOH/g or more and 300 mg KOH/g or less.

The acid value can be determined, for example, by a method conforming to JIS K 0070:1992 “Test Methods for Acid Value, Saponification Value, Ester Value, Iodine Value, Hydroxyl Value, and Unsaponifiable Matter of Chemical Products.”

A mass average molecular weight of the pigment dispersion resin is preferably 3000 or more and 30000 or less, more preferably 4000 or more and 25000 or less, and most preferably 5000 or more and 20000 or less. When the mass average molecular weight of the pigment dispersion resin is less than 3000, the dispersion stability of the pigment may decrease. When the mass average molecular weight of the pigment dispersion resin is greater than 30000, the ink ejection stability may decrease.

In this specification, a mass average molecular weight refers to a mass average molecular weight measured by gel permeation chromatography and expressed in polystyrene equivalents.

It is preferable that the pigment dispersion resin be neutralized by a basic compound. The basic compound is not particularly limited, but examples include lithium hydroxide, sodium hydroxide, potassium hydroxide, calcium hydroxide, barium hydroxide, ammonia, trimethylamine, triethylamine, 2-(dimethylamino) ethanol, 2-(diethylamino) ethanol, triethanolamine, and 2-amino-2-methyl-1-propanol.

The basic compounds may be used alone or in combination of two or more types.

In this specification, a neutralization degree means a ratio of an equivalent amount of the basic compound to an equivalent amount of the acid group in the pigment dispersion resin.

$$The neutralization degree ( \% ) = [ \{ Mass of basic compound ( g ) \times 56.11 \times 1000 \} / \{ Acid value of pigment dispersion resin ( mg KOH / g ) \times Equivalent amount of basic compound \times Mass of pigment dispersion resin ( g ) \} ] \times 100$$

The neutralization degree calculated by the above formula is preferably 30% or more and 100% or less, and more preferably 50% or more and 90% or less.

A ratio of a mass of the pigment dispersion resin to a mass of the pigment is preferably 0.10 or more and 0.55 or less, more preferably 0.25 or more and 0.50 or less, and most preferably 0.30 or more and 0.45 or less. When the ratio of the mass of the pigment dispersion resin to the mass of the pigment is within this range, it is easier to adjust ink viscosity to a range suitable for the inkjet recording. When the ratio of the mass of the pigment dispersion resin to the mass of the pigment is less than 0.10, the dispersion stability of the pigment may decrease.

The pigment dispersion resin may be used alone or in combination with two or more types.

### (Surfactant)

The aqueous ink for inkjet recording of the present disclosure may further contain a surfactant. Examples of the surfactant include an acetylene glycol based surfactant, an acrylic based surfactant, and a silicone based surfactant. As the surfactant, a commercially available product may be used.

A commercially available product of the acetylene glycol based surfactant includes, for example, Surfynol (registered trademark) 420, Surfynol (registered trademark) 440 (both manufactured by Evonik Industries AG, product names); Olfin (registered trademark) E1010, Olfin EXP. 4200, Olfin EXP. 4300, and Olfin PD-002W (all manufactured by Nissin Chemical Industry Co., Ltd., product names).

A commercially available product of the acrylic based surfactant includes, for example, BYK (registered trademark)-380 N, BYK-381 (both manufactured by BYK Japan Ltd., product names); Polyflow KL-850 (manufactured by Kyoeisha Chemical Co., Ltd., product name).

A commercially available product of the silicone based surfactant includes, for example, Silface (registered trademark) SAG002 and Silface (registered trademark) SAG503A (both manufactured by Nissin Chemical Industry Co., Ltd., product names).

The surfactants may be used alone or in combination of two or more types.

A content of the surfactant is preferably 0.05 mass % or more and 2 mass % or less with respect to the total mass of the ink. When the content of the surfactant is within this range, it is easier to adjust dynamic surface tension of the ink to a range suitable for the inkjet recording.

In this specification, the dynamic surface tension refers to surface tension measured at 50 ms using a maximum bubble pressure method. For measuring the dynamic surface tension by the maximum bubble pressure method, a dynamic surface tension meter (product name: BP100) manufactured by KRUSS GmbH, for example, can be used.

### (Other Components)

The aqueous ink for inkjet recording of the present disclosure may further contain other components within a range that does not impair the effects of the present disclosure. Other components are not particularly limited, but include a pH adjuster, a chelating agent, a preservative, and an antifungal agent.

The other components may be used alone or in combination with two or more types. Contents of other components are not particularly limited and may be set appropriately as necessary.

### (Method for Producing Pigment Dispersion)

A method for producing the pigment dispersion is not particularly limited, but includes, for example, mixing and stirring the pigment, the dispersant, and an aqueous medium, followed by dispersion using a disperser.

The disperser is not particularly limited, but examples include a ball mill, an attritor (manufactured by Nippon Coke & Engineering Co., Ltd., registered trademark), and a bead mill. Among these, the bead mill is preferably used. Examples of the bead mill include, for example, Sand Grinder (manufactured by AIMEX Co., Ltd., product name), DYNO-MILL (manufactured by Shinmaru Enterprises Co., Ltd., product name), and Ultra Apex Mill (manufactured by Hiroshima Metal & Machinery Co., Ltd., product name).

When coarse particles are included in the obtained pigment dispersion, it is preferable to remove the coarse particles by a method such as filtration or centrifugation. Removing the coarse particles prevents clogging of an inkjet head nozzle.

### (Method for Producing Ink)

According to the present disclosure, a method for producing the aqueous ink for inkjet recording including the pigment, the compound represented by the general formula (1), the glycol ether, and water includes a step of mixing the pigment dispersion, the compound represented by the general formula (1), the glycol ether, water, optionally other water-soluble organic solvents, surfactants, and other components.

The method for producing the aqueous ink for inkjet recording of the present disclosure may further include a step of removing insolubles by filtration.

From the perspective of ensuring the ink ejection stability, viscosity of the ink at 25° C. is preferably 3 mPa·s or more and 10 mPa·s or less, and more preferably 4 mPa·s or more and 9 mPa·s or less.

The viscosity of the ink can be determined, for example, by a method conforming to JIS Z 8803:2011 “Method for Measuring Viscosity of Liquid”.

From the perspective of ensuring the ink ejection stability, the dynamic surface tension of the aqueous ink for inkjet recording of the present disclosure is preferably 30 mN/m or more and 40 mN/m or less. When the dynamic surface tension of the ink is less than 30 mN/m, the ink ejection stability may decrease.

### (Inkjet Recording Method)

An inkjet recording method of this embodiment is a method for recording an image by ejecting ink from a recording head of an inkjet recording device, including a step of forming an image by adhering ink droplets to a recording medium.

The ejection of the aqueous ink for inkjet recording of the present disclosure can be performed using a known inkjet recording device.

The aqueous ink for inkjet recording of the present disclosure is suitable for printing on plain paper. In this specification, the plain paper refers to uncoated paper such as fine paper. Examples of plain paper include C2 (C-Two) (manufactured by Fujifilm Business Innovation Corporation, registered trademark), Color Copy (manufactured by Mondi, registered trademark), Laser Print (manufactured by Hammermill, product name), and Vitality (manufactured by Xerox, product name).

### EXAMPLES

The following examples are provided to further illustrate the present disclosure, but the disclosure is not limited thereto.

The mass average molecular weight of the pigment dispersion resin was measured by the gel permeation chromatography. Measurement conditions are shown below.

### (Measurement Conditions)

Measuring Instrument: HLC-8020GPC (Tosoh Corporation, product name)
Column: TSKgel (registered trademark) SuperMultipore HZ-H (Tosoh Corporation, product name)
Elution solvent: Tetrahydrofuran
Flow rate: 0.35 mL/min
Detection: RI
Temperature: 40° C.

### (Pigment Dispersion Resin 1)

As a pigment dispersion resin 1, a potassium hydroxide neutralized matter of 22 parts by mass of styrene, 44 parts by mass of α-methylstyrene, 6 parts by mass of 2-hydroxyethyl acrylate, and 28 parts by mass of methacrylic acid (mass average molecular weight: 9100, acid value: 200 mg KOH/g) was used.

### (Pigment Dispersion Resin 2)

As a pigment dispersion resin 2, a potassium hydroxide neutralized matter of 32 parts by mass of styrene, 32 parts by mass of α-methylstyrene, and 36 parts by mass of methacrylic acid (mass average molecular weight: 6900, acid value: 250 mg KOH/g) was used.

### (Preparation of Pigment Dispersion 1)

20 parts by mass of carbon black, 30 parts by mass of a 20% aqueous solution of the pigment dispersion resin 1, and 50 parts by mass of ion-exchanged water were mixed and stirred. The mixture was then dispersed using a bead mill filled with zirconia beads with a diameter 0.1 mm. Coarse particles were subsequently removed by centrifugation. The ion-exchanged water was added to obtain pigment dispersion 1 with a pigment concentration of 15 mass %.

### (Preparation of Pigment Dispersion 2)

Except for using the pigment dispersion resin 2 instead of the pigment dispersion resin 1, the preparation was the same as for the pigment dispersion 1, obtaining pigment dispersion 2 with a pigment concentration of 15 mass %.

### Examples 1 to 10 and Comparative Examples 1 to 3

Each ink was prepared by mixing respective components to achieve each composition shown in Table 1, followed by filtration using a membrane filter with a pore size of 5 μm.

The respective components used in Examples and Comparative Examples are listed below.

### (Compound Represented by General Formula (1))

n=3 (Manufactured by Fujifilm Wako Pure Chemical Corporation, product name: tripropylene glycol (isomer mixture))
n=7 (Manufactured by Fujifilm Wako Pure Chemical Corporation, product name: polypropylene glycol, diol type, 400)
n=12 (Manufactured by Fujifilm Wako Pure Chemical Corporation, product name: polypropylene glycol, diol type, 700)
n=17 (Manufactured by Fujifilm Wako Pure Chemical Corporation, product name: Polypropylene Glycol, Diol type, 1000)

### (Glycol Ether)

Propylene glycol monomethyl ether
Propylene glycol monopropyl ether
Dipropylene glycol monomethyl ether
Dipropylene glycol monopropyl ether
Triethylene glycol monobutyl ether

### (Other Water-Soluble Organic Solvent)

1,2-propanediol
1,3-propanediol

### (Surfactant)

Acetylene glycol based surfactant (manufactured by Evonik Industries AG, product name: Surfynol 440)

### (Recording Medium)

Each recording medium used in Examples and Comparative Examples is shown below.
Manufactured by Fujifilm Business Innovation Corporation, product name: C2 (C-Two), basis weight: 70 g/m²
Manufactured by Mondi, product name: Color Copy, Basis Weight: 90 g/m²

### (Evaluation)

The following evaluations were performed on the inks used in Examples 1 to 10 and Comparative Examples 1 to 3. The results are shown in Table 1.

### (Image Density)

Each ink was filled into a recording head of an inkjet recording device (manufactured by Kyocera Corporation, product name: KJ4B-QA, resolution: 600 dpi×600 dpi), and an ink ejection volume was set to 11 μL.

Using the above inkjet recording device, a solid image was printed onto the recording medium and dried at room temperature for 24 hours. The image density of the resulting solid image was measured using a fluorescence spectrophotometer (manufactured by Konica Minolta, Inc., product name: FD-5) and evaluated according to the following criteria. A and B were considered pass.
A: Image density of 1.18 or more
B: Image density of 1.14 or more and less than 1.18
C: Image density of less than 1.14

TABLE 1

| | | | Example | | | | | | |
|---|---|---|---|---|---|---|---|---|---|
| | | | 1 | 2 | 3 | 4 | 5 | 6 | 7 |
| [symbol] | Pigment dispersion | Pigment dispersion 1 | [symbol] | [symbol] | [symbol] | [symbol] | [symbol] | [symbol] | [symbol] |
| [symbol] | | Pigment dispersion 2 | | | | | | | |
| | [symbol] | [symbol] | | | | | | 12 | |
| | [symbol] | [symbol] | 12 | 12 | 12 | 12 | 12 | | |
| | [symbol] | [symbol] | | | | | | | 12 |
| | | [symbol] | | | | | | | |
| | [symbol] | [symbol] | 12 | | | | | | |
| | | [symbol] | | 12 | | | | | |
| | | [symbol] | | | 12 | | | [symbol] | [symbol] |
| | | [symbol] | | | | 12 | | | |
| | | [symbol] | | | | | 12 | | |
| | [symbol] | [symbol] | | | | | | | |
| | [symbol] | [symbol] | | | | | | | |
| | [symbol] | [symbol] | [symbol] | [symbol] | [symbol] | [symbol] | [symbol] | [symbol] | [symbol] |
| | [symbol] | [symbol] | Remainder | Remainder | Remainder | Remainder | Remainder | Remainder | Remainder |
| | Total | | 100 | 100 | 100 | 100 | 100 | [symbol] | [symbol] |
| | [symbol] | | [symbol] | [symbol] | [symbol] | [symbol] | [symbol] | [symbol] | [symbol] |
| | [symbol] | | | | | | | | |
| | [symbol] | | | | | | | | |
| [symbol] | [symbol] | [symbol] | B | B | B | B | B | B | B |
| | | [symbol] | A | A | A | A | A | A | A |

| | | | Example | | | Comparative Example | | |
|---|---|---|---|---|---|---|---|---|
| | | | 8 | 9 | 10 | 1 | 2 | 3 |
| [symbol] | Pigment dispersion | Pigment dispersion 1 | | [symbol] | [symbol] | [symbol] | [symbol] | [symbol] |
| [symbol] | | Pigment dispersion 2 | [symbol] | | | | | |
| | [symbol] | [symbol] | | | | | | |
| | [symbol] | [symbol] | 12 | | [symbol] | | | 12 |
| | [symbol] | [symbol] | | | | | | |
| | | [symbol] | | 2 | | | | |
| | [symbol] | [symbol] | | | | | | |
| | | [symbol] | | | | | | |
| | | [symbol] | [symbol] | [symbol] | [symbol] | [symbol] | [symbol] | |
| | | [symbol] | | | | | | |
| | | [symbol] | | | | | | |
| | [symbol] | [symbol] | | | | [symbol] | | |
| | [symbol] | [symbol] | | | | | [symbol] | [symbol] |
| | [symbol] | [symbol] | [symbol] | [symbol] | [symbol] | [symbol] | [symbol] | [symbol] |
| | [symbol] | [symbol] | Remainder | Remainder | Remainder | Remainder | Remainder | Remainder |
| | Total | | 100 | [symbol] | 100 | [symbol] | [symbol] | [symbol] |
| | [symbol] | | [symbol] | [symbol] | [symbol] | [symbol] | [symbol] | [symbol] |
| | [symbol] | | | | | | | |
| | [symbol] | | | | | | | |
| [symbol] | [symbol] | [symbol] | B | B | B | C | C | C |
| | | [symbol] | A | A | A | [symbol] | B | [symbol] |

[symbol]

indicates data missing or illegible when filed

As shown in Table 1, Examples 1 to 10 exhibited good image density. In Comparative Examples 1 and 2, the image density was low because it did not contain the compound represented by general formula (1). In Comparative Example 3, the image density was low because it did not contain glycol ether.

According to this embodiment, the glycol ether is selected from propylene glycol monomethyl ether, propylene glycol monopropyl ether, dipropylene glycol monomethyl ether, dipropylene glycol monopropyl ether, and triethylene glycol monobutyl ether. The content of the compound represented by general formula (1) is 10 mass parts or more and 80 mass parts or less with respect to 100 mass parts of the total of the compound represented by general formula (1) and the glycol ether. This enables to provide the aqueous ink for inkjet recording capable of improving the image density on plain paper.

It should be understood by those skilled in the art that various modifications, combinations, sub-combinations and alterations may occur depending on design requirements and other factors insofar as they are within the scope of the appended claims or the equivalents thereof.

What is claimed is:

1. An aqueous ink for inkjet recording, comprising: a pigment; a compound represented by the following general formula (1); a glycol ether; and water,
wherein the glycol ether is at least one selected from propylene glycol monomethyl ether, propylene glycol monopropyl ether, dipropylene glycol monomethyl ether, dipropylene glycol monopropyl ether, and triethylene glycol monobutyl ether, and
wherein a content of the compound represented by the following general formula (1) is 10 mass parts or more and 80 mass parts or less with respect to a total of 100 mass parts of the compound represented by the following general formula (1) and the glycol ether, 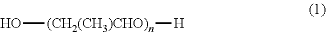
in the above general formula (1), n represents an average number of repeating oxypropylene groups and is an integer of 3 or more and 17 or less.

2. The aqueous ink for inkjet recording according to claim 1, wherein
the content of the compound represented by the above general formula (1) is 2 mass % or more and 16 mass % or less with respect to the total mass of the ink.
